(19) United States
(12) Patent Application Publication
(10) Pub. No.: US 2025/0080511 A1
(43) Pub. Date: Mar. 6, 2025

(54) AI AND BLOCKCHAIN ENHANCED END-TO-END MESSAGING SYSTEMS AND METHODS

(71) Applicants: YUJI OGAWA, Elkridge, MD (US); ANDREW CONTICELLI, Albuquerque, NM (US); LUIS M. ORTIZ, Albuquerque, NM (US)

(72) Inventors: YUJI OGAWA, Elkridge, MD (US); ANDREW CONTICELLI, Albuquerque, NM (US); LUIS M. ORTIZ, Albuquerque, NM (US)

(21) Appl. No.: 18/822,168

(22) Filed: Aug. 31, 2024

Related U.S. Application Data
(60) Provisional application No. 63/536,287, filed on Sep. 1, 2023.

(51) Int. Cl. H04L 9/40; G06F 40/166; G06F 40/253; G06F 40/35; G06F 40/58; G06V 30/19; H04L 51/04

(52) U.S. Cl. CPC H04L 63/0428; G06F 40/166; G06F 40/253; G06F 40/35; G06V 30/19; H04L 51/04; G06F 40/58

(57) ABSTRACT

An end-to-end messaging including AI and blockchain enhancements to enhance user experience while engaged in networking and matchmaking. Progressive AI-based unobscuring techniques can be applied to an image to predict and selectively unobscure parts of the image in response to the progressive exchange of user messages. A user's images and information can be fully unobscured in response to additional message exchanges between users. A cryptographic hash of the image can be generated and recorded on a blockchain ledger to establish an immutable record of the submitted image. Message exchanges and related metadata can be recorded on the blockchain, establishing a transparent and traceable communication history. Natural language processing algorithms can translate, enhance grammar, and adjust sentiment of messages, or suggest any of these, before they are provided from one user to another user.

### INVENTION PRIORITY

The present invention and its embodiment claim priority to U.S. Priority Application No. 63/536,287, entitled “AI and Blockchain enhanced end-to-end messaging systems and methods”, filed Sep. 1, 2023, which is incorporated herein by reference.

### TECHNICAL FIELD

The present embodiments generally relate to computer messaging systems and more particularly to an end-to-end messaging process system and method. More particularly, the present embodiments are related to an end-to-end messaging system and methods that can be enhanced by either or both of artificial intelligence and blockchain technology.

### BACKGROUND

Online communities, such as those facilitated by dating websites, social networking websites or application programs, allow users to search for and communicate with other users. Some such communities include many users with a wide variety of interests. A large number of users can provide an individual with a great deal of choice in finding someone with whom to chat and potentially meet in the real world.

Still, a tradeoff to having a large community of users is that choice paralysis and time may keep users overloaded with people to message back and forth with, with no reward system for messaging back. For example, some individuals may decide whether or not to message another user without meaningfully evaluating information that the other user has posted as part of a profile page. As such, user decisions regarding whether to message other users may become based on superficial characteristics, such as a single picture and limited information of the users' personality or profile.

What is needed are enhancements to present social networking and messaging services and systems that can enhance user experience and satisfaction.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

The embodiments described herein include techniques, methods, systems, and other mechanisms for managing and revealing information in an end-to-end messaging system, whether stand alone or as part of a social networking service, based on user interaction. In general, this disclosure relates to a computing system that facilitates communication between members of an online community, such as a computing system that supports a dating website or a dating application program designed for mobile devices.

It should be appreciated that the present systems application can include a variety of services to include those provided by business networking applications and other online networking services. The computing system may allow users to upload profiles of themselves and view profiles of other users, and the computing system may initially obscure at least some of the information in those user profiles (e.g., pictures, personal information, documents, and social medias). The obscured information may be revealed once various criteria are met, such as two users having exchanged messages or a certain number of messages.

It is therefore on aspect of the embodiments to provide for improved end-to-end messaging including AI and blockchain enhancements to enhance user experience while engaged in networking and matchmaking.

It is therefore on aspect of the embodiments that progressive AI-based unobscuring techniques can be applied to an image to predict and selectively unobscure parts of the image in response to the progressive exchange of user messages.

It is therefore on aspect of the embodiments that a user's images and information can be fully unobscured in response to additional message exchanges between users.

It is therefore on aspect of the embodiments that a cryptographic hash of the image can be generated and recorded on a blockchain ledger to establish an immutable record of the submitted image.

It is therefore on aspect of the embodiments that message exchanges and related metadata can be recorded on the blockchain, establishing a transparent and traceable communication history.

It is therefore another aspect of the embodiments that natural language processing algorithms can translate, enhance grammar, and adjust sentiment of messages, or suggest any of these, before they are provided from one user to another user.

In accordance with some of the embodiments of a computing system for enhancing secure and transparent communication between user accounts, an AI-powered image recognition module can be configured to receive images submitted by user accounts and automatically identify sensitive content within said images. A blockchain ledger can record cryptographic hashes of submitted images to establish an immutable and tamper-proof record of image submissions. An image editing module utilizing AI-based techniques can obscure sensitive parts of the image while retaining the integrity of the remaining parts. A natural language processing module can enhance user messages for improved grammar and sentiment. A recommendation system can analyze user behavior and interactions to determine optimal message delivery times. A blockchain-based ledger can be utilized to store message exchanges, user interactions, and related metadata, ensuring transparent and traceable communication. A progressive unobscuring module using machine learning can be utilized to gradually reveal parts of obscured images based on user interactions. An AI-driven security module employing content filtering, anomaly detection, and blockchain-based identity verification can be utilized to ensure safe and secure user interactions. Chatbots powered by AI and blockchain-based identity management can be utilized to assist users and provide contextually accurate responses. Sentiment analysis algorithms can be utilized to determine emotional tone for appropriate interventions. Personalization algorithms can be utilized for analyzing user preferences and blockchain-based user consent to customize message and image displays. Accessibility features including AI-enabled image captioning, text-to-speech, and blockchain-enhanced data control mechanisms to cater to diverse user needs can be employed.

In accordance with some of the embodiments of a method for facilitating secure communication between user accounts in a computing system, a first computing device associated with a first user account can receive an image submitted by a second user account. An AI-based image recognition algorithm can be applied to identify sensitive content within said image. At least parts of the image can be automatically obscured based on the identified sensitive content using an AI-powered image editing technique. The obscured image can be displayed on the first computing device. A first user input containing a first user message can be received by the system. The first user message can be sent to a second computing device associated with a second user account. Optionally and before the message is sent, natural language processing algorithms can be utilized to translate, enhance grammar, and adjust sentiment of messages, or suggest any of these, before they are provided from one user to another user. A second user message can be received from the second computing device. Progressive AI-based unobscuring techniques can be utilized to predict and selectively unobscure parts of the image in response to the second user message. The image with progressively reduced obfuscation can be displayed on the first computing device. The image can become fully unobscured in response to additional messages being exchanged between the first user account and the second user account. The additional messages required can determined by AI-driven recommendations.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a block diagram of a system for managing the provisional of personal information in an end-to-end messaging system utilizing AI technology, in accordance with aspects of the embodiments;

FIG. 2 illustrates a block diagram of another system for managing the provisional of personal information in an end-to-end messaging system in the form of a dating system, in accordance with aspects of the embodiments;

FIG. 3 illustrates a block diagram of a system for managing the provisional of personal information in an end-to-end messaging system utilizing blockchain technology, in accordance with aspects of the embodiments;

FIG. 4 illustrates a block diagram of a system for managing the provisional of personal information in an end-to-end messaging system utilizing AI and blockchain technologies, in accordance with aspects of the embodiments;

FIG. 5 illustrates a flow diagram of a method for facilitating secure communication between user accounts in a computing system, in accordance with aspects of the embodiments;

FIG. 6 illustrates a flow diagram of another method for facilitating secure communication between user accounts in a computing system, in accordance with aspects of the embodiments;

FIG. 7 illustrates a flow diagram of another method for secure and transparent communication between user accounts in a computing system, in accordance with aspects of the embodiments; and

FIG. 8 illustrates a flow diagram of an example method for facilitating secure communication between two user accounts created within a matchmaking application, in accordance with aspects of the embodiments.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Furthermore, the term “at least one” as utilized herein can refer to “one or more”. For example, “at least one widget” may refer to “one or more widgets.”

Note that the term “processor” as utilized herein can relate a component of an electronic device that executes programming instructions. The term “processor” may refer to either a single processor or to multiple processors that together implement various steps of a process. Unless the context specifically states that a single processor is required or that multiple processors are required, the term “processor” includes both the singular and plural embodiments.

“Computer programs” (also called computer control logic) and including one or more modules may be stored in a main memory and/or the secondary memory. Computer programs or modules may also be received via a communications interface. Such computer programs or modules, when executed, can enable the computer system to perform the features and capabilities provided herein. Software and data transferred via the communications interface can be in the form of signals which may be, for example, electronic, electromagnetic, optical, or other signals capable of being received by a communications interface. These signals can be provided to a communications interface via a communications path (i.e., channel), which carries signals and may be implemented using wire, cable, and fiber optic, phone line

The term “data” as utilized herein can relate to physical signals that indicate or include information. An “image,” as a pattern of physical light or a collection of data representing the physical light, may include characters, words, and text as well as other features such as graphics.

A “digital image” can be by extension an image represented by a collection of digital data. An image may be divided into “segments,” each of which is itself an image. A segment of an image may be of any size up to and including the whole image. The term “image object” or “object” as used herein is believed to be considered in the art generally equivalent to the term “segment” and will be employed herein interchangeably.

In a digital image composed of data representing physical light, each element of data may be called a “pixel,” which is common usage in the art and refers to a picture element. Each pixel has a location and value. Each pixel value is a bit in a “binary form” of an image, a gray scale value in a “gray scale form” of an image, or a set of color space coordinates in a “color coordinate form” of an image, the binary form, gray scale form, and color coordinate form each being a two-dimensional array defining an image. An operation can perform “image processing” when it operates on an item of data that relates to part of an image.

Several aspects of data-processing systems will now be presented with reference to various systems and methods. These systems and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A mobile “app” is an example of such software.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer.

The disclosed example embodiments are described at least in part herein with reference to flowchart illustrations and/or block diagrams and/or schematic diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks.

To be clear, some embodiments may be implemented in the context of, for example a special-purpose computer or a general-purpose computer, or other programmable data processing apparatus or system. For example, in some example embodiments, a data processing apparatus or system can be implemented as a combination of a special-purpose computer and a general-purpose computer. The computer program product may include a computer readable storage medium (or media) having computer readable program instructions thereon for causing a processor to carry out aspects of the embodiments.

The aforementioned computer program instructions may also be stored in a computer-readable memory that can direct a computer or other programmable data processing apparatus to function in a particular manner, such that the instructions (e.g., steps/operations) stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flow charts and block diagrams in the figures illustrate the architecture, functionality, and operation of possible implementations of systems, methods, and computer program products according to various embodiments (e.g., preferred, or alternative embodiments). In this regard, each block in the flow chart or block diagrams depicted and described herein can represent a module, segment, or portion of instructions, which can comprise one or more executable instructions for implementing the specified logical function(s).

In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The functionalities described herein may be implemented entirely and non-abstractly as physical hardware, entirely as physical non-abstract software (including firmware, resident software, micro-code, etc.) or combining non-abstract software and hardware implementations that may be referred to herein as a “circuit,” “module,” “engine”, “component,” “block”, “database”, “agent” or “system.” Furthermore, aspects of the present disclosure may take the form of a computer program product embodied in one or more non-ephemeral computer readable media having computer readable and/or executable program code embodied thereon.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” (also referred to as an “engine”) may constitute a software application but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which may be typically private (accessible only to that module), and which includes source code that actually implements the routines in the module. The term module may also simply refer to an application, such as a computer program designed to assist in the performance of a specific task, such as word processing, accounting, inventory management, etc.

In some example embodiments, the term “module” can also refer to a modular hardware component or a component that is a combination of hardware and software. It should be appreciated that implementation and processing of such modules according to the approach described herein can lead to improvements in processing speed and in energy savings and efficiencies in a data-processing system such as, for example, the system and methods described herein. A “module” can perform the various steps, operations or instructions discussed herein, such as the steps or operations discussed herein.

The term “watermark” as utilized herein can relate to a piece of a transparent text, image, logo, or other markings that can be applied to media (e.g., a document, paper, a photo, an image, etc.), which can make it more difficult to copy or counterfeit the media (to which the watermark is applied through security printing) or use it without permission. A “watermark” can be a special-purpose text or picture that can be printed across one or more pages. For example, one can add a word like Copy, Draft, or Confidential as a watermark instead of stamping it on a document before distribution.

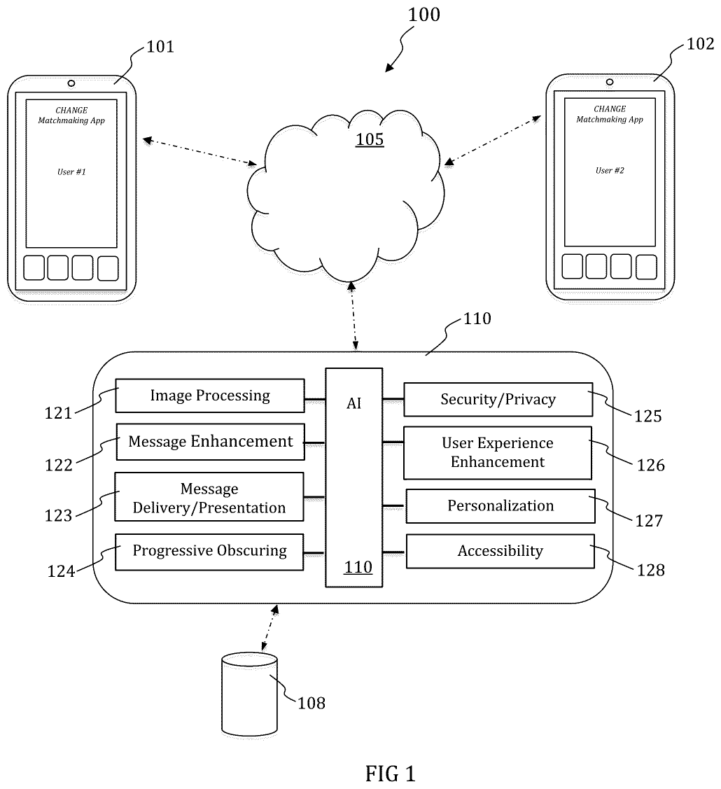

Various AI techniques can be implemented into an end-to-end messaging system or social networking systems with messaging to improve user experience, automate processes, and enhance security. Referring to FIG. 1, illustrated is a block diagram 100 of an end-to-end messaging system 110 in accordance with an embodiment. A first client 101 is shown in communication with second client 102 via the end-to-end messaging system 110 and over a data communications network 105. Communications can be via wired or wireless networking, and clients can be desktop or portable computers, such as smartphones. The block diagram 100 shows how an AI engine 120 can be accessed and utilized as part of an end-to end messaging system 110 to manage user profile information stored in a database 108, and also to enhance each step of the processes described herein.

Image Processing module 121: The end-to end messaging system 110 can utilize AI-based image recognition provided by the AI engine 120 to automatically detect sensitive content in the images submitted by users of clients 101/102. This can help in determining what parts of the image need to be obscured. AI-powered image editing can be applied to efficiently obscure the sensitive parts of the image while retaining the integrity of the rest of the image.

Message Enhancement module 122: The end-to end messaging system 100 can utilize AI-based image recognition provided by the AI engine 120 to implement natural language processing (NLP) algorithms to enhance user messages. For example, AI can help in improving grammar, sentiment, and overall readability of user messages during communications with other users. The AI engine 110 can provide auto-suggestions to users as they compose messages, based on the context of the conversation, to help them communicate more effectively.

Message Delivery and Presentation module 123: The end-to end messaging system 100 can utilize AI-based image recognition provided by the AI engine 120 to utilize AI-driven recommendation systems to determine the optimal time to deliver messages to users based on their past behaviors and online activity. The AI engine 120 can employ AI-generated summaries of the messages exchanged, allowing users to quickly grasp the key points without reading through the entire conversation.

Progressive Unobscuring module 124: The end-to end messaging system 100 can utilize AI-based image recognition provided by the AI engine 120 to implement a machine learning model that gradually predicts which parts of the obscured image are more likely to be non-sensitive based on previous interactions. This way, the image can be unobscured in a visually appealing and user-friendly manner.

Security and Privacy module 125: The end-to end messaging system 100 can utilize AI-based image recognition provided by the AI engine 120 to implement AI-based content filtering to ensure that no inappropriate or harmful content is shared between users, enhancing the security and integrity of the platform. Use AI-driven anomaly detection to identify unusual user behaviors, potentially indicating unauthorized account access or malicious activity.

User Experience Enhancement module 126: The end-to end messaging system 100 can utilize AI-based image recognition provided by the AI engine 120 to incorporate AI-powered chatbots to provide instant assistance to users, answer their questions, and guide them through the process. Utilize sentiment analysis to gauge the emotional tone of the conversation and provide appropriate responses or interventions.

Personalization module 127: The end-to end messaging system 100 can utilize AI-based image recognition provided by the AI engine 120 to leverage AI to analyze user preferences, interactions, and content consumption patterns to tailor the display of messages and images according to individual user tastes.

Accessibility module 128: The end-to end messaging system 100 can utilize AI-based image recognition provided by the AI engine 120 to implement AI-driven accessibility features such as image captioning, text-to-speech, and language translation to ensure that the platform is usable by a wide range of users.

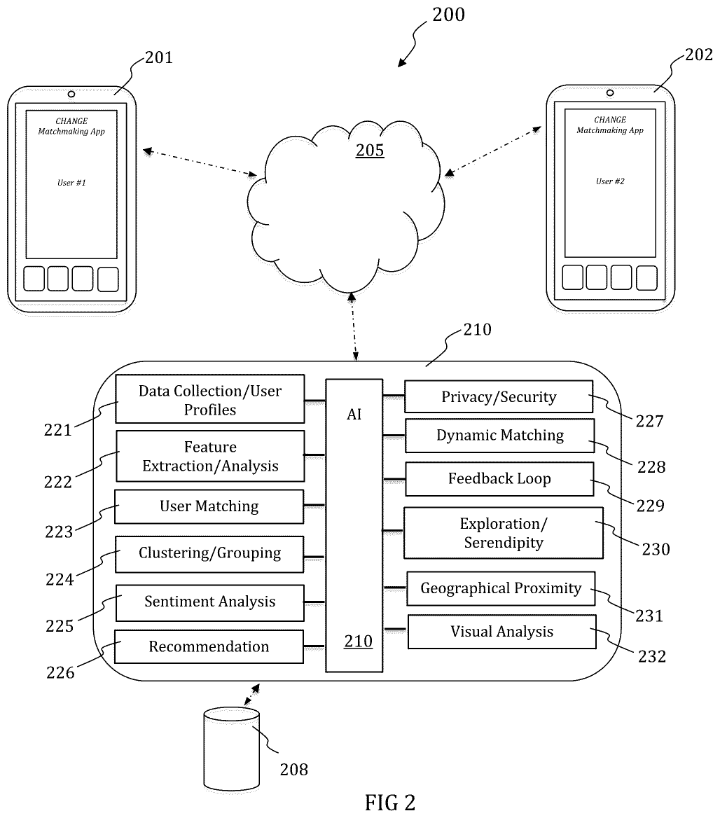

To implement AI-powered monitoring and suggestion features in a dating application, what can be used is a combination of machine learning, natural language processing, and recommendation systems. Referring to FIG. 2, illustrated is a block diagram 200 of dating system 210, in accordance with another embodiment. A first client 201 is shown in communication with second client 202 via the dating system 210 and over a data communications network 205. Once again, communications can be via wired or wireless networking, and clients can be desktop or portable computers, such as smartphones. The block diagram 200 shows how an AI engine 220 can be accessed and utilized as part of dating system 210 to manage user profile information stored in a database 208, and also to enhance each step of the processes further described herein.

Data Collection and User Profiles module 221: The dating system 210 can utilize AI-based image recognition provided by the AI engine 220 to collect detailed information from users during the onboarding process. Data can be stored in and/or retrieved from database 208. This includes demographic data, interests, hobbies, preferences, and more. Demographic information can be contained in user profiles as part of the users' accounts and can include at least one item selected from a group including: a height of a user; an age of a user; a geographic location of a user; a profession of a user; a relationship status of a user; a religion of a user; a biographical description of a user; an ethnicity of a user; a body type of a user; whether a user smokes; whether a user drinks alcohol; whether a user does drugs; an educational level of a user; and a language spoken by a user. This data can be used to create comprehensive user profiles that highlight the unique attributes and characteristics of each user.

Feature Extraction and Analysis module 222: The dating system 210 can utilize AI-based image recognition provided by the AI engine 220 to apply natural language processing to analyze users' written profiles, interests, and messages to extract important keywords and themes. Utilize machine learning algorithms to find patterns and similarities between users based on their profiles, behaviors, and interactions.

User Matching module 223: The dating system 210 can utilize AI-based image recognition provided by the AI engine 220 to employ collaborative filtering techniques to find potential matches by comparing users with similar interests, preferences, and behavior. The dating system 210 can use content-based filtering to match users based on the content they provide in their profiles, messages, and interactions.

Clustering and Grouping module 224: The dating system 210 can utilize AI-based image recognition provided by the AI engine 220 to utilize clustering algorithms to group users with similar attributes into clusters or segments. This can help in suggesting not only individual matches but also social events or group activities for users with common interests.

Sentiment Analysis module 225: The dating system 210 can utilize AI-based image recognition provided by the AI engine 220 to analyze the sentiment and emotional tone of user interactions to gauge the compatibility and chemistry between users. The dating system 210 can recommend matches where positive sentiment is prevalent in conversations.

Recommendation Engine 226: The dating system 210 can utilize AI-based image recognition provided by the AI engine 220 to build a recommendation engine that continually learns from user interactions and behaviors to provide more accurate and relevant match suggestions over time. The dating system 210 can incorporate reinforcement learning to improve the quality of recommendations based on user feedback.

Privacy and Security module 227: The dating system 210 can utilize AI-based image recognition provided by the AI engine 220 to implement strict privacy controls and data protection measures to ensure users' sensitive information remains secure and confidential.

Dynamic Matching module 228: The dating system 210 can utilize AI-based image recognition provided by the AI engine 220 to use AI to dynamically adjust match suggestions as users provide more information and engage in interactions, improving the accuracy of matches over time.

Feedback Loop 229: The dating system 210 can utilize AI-based image recognition provided by the AI engine 220 to encourage users to provide feedback on suggested matches. The dating system 210 can utilize this feedback to fine-tune the matching algorithms and improve user satisfaction.

Exploration and Serendipity module 230: The dating system 210 can utilize AI-based image recognition provided by the AI engine 220 to introduce an element of randomness in the suggestions to allow users to discover potential matches that they might not have considered otherwise.

Geographical Proximity module 231: The dating system 210 can utilize AI-based image recognition provided by the AI engine 220 to incorporate location-based algorithms to suggest matches who are geographically closer, promoting real-world interactions.

Visual Analysis module 232: The dating system 210 can utilize AI-based image recognition provided by the AI engine 220 to implement image analysis algorithms to suggest matches based on facial features, expressions, and visual similarities.

While AI can significantly enhance the matching process, it's important to provide users with control over their preferences and to be transparent about the use of AI algorithms. Regularly updating and refining the AI models based on user feedback and behaviors can lead to better matches and user engagement over time.

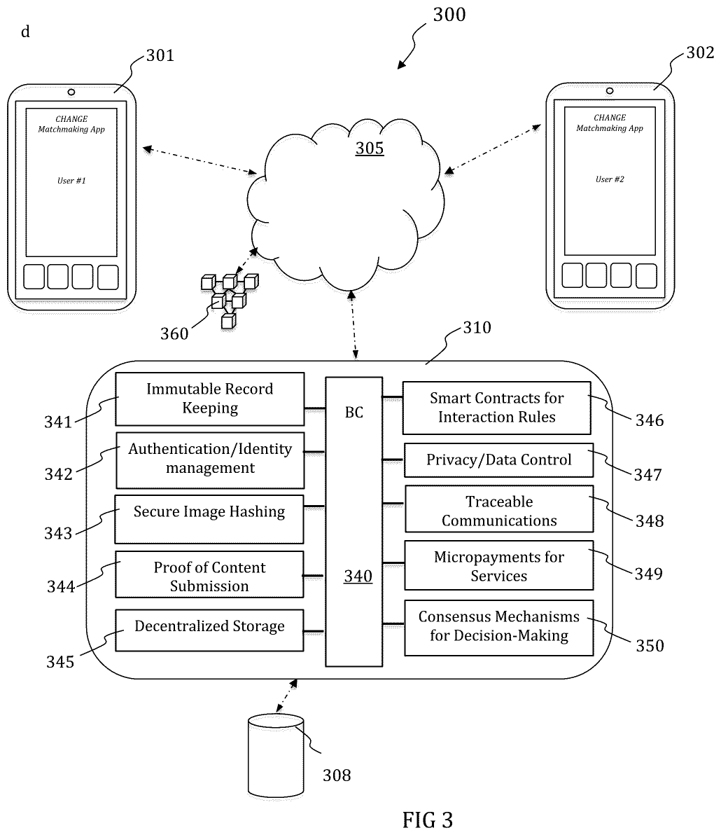

Integrating blockchain technology (which can also be referred to as distributed ledger technology) can add an extra layer of security, transparency, and trust to the described invention. Referring to FIG. 3, illustrated is a block diagram 300 of end-to-end messaging system 310, in accordance with an embodiment. The block diagram shows how a distributed ledger module 340 can be utilized as part of the end-to-end messaging system 310 supporting communications over data network 305 between two clients, 301/302 to provide blockchain 360 access and functionality and enhance each step of certain processes described herein.

Immutable Record keeping module 341: The end-to-end messaging system 310 can utilize blockchain technology provided by the distributed ledger module 340 to utilize blockchain 360 to create an immutable ledger that records all interactions and transactions between user accounts. Each message exchange, image submission, and interaction can be timestamped and stored in a secure, decentralized manner on the blockchain 360.

Authentication and Identity Management module 342: The end-to-end messaging system 310 can utilize blockchain technology provided by the distributed ledger module 340 to implement blockchain-based identity management to enhance user authentication and verification. User account information can be stored in a blockchain 360, reducing the risk of unauthorized access and identity theft.

Secure Image Hashing module 343: The end-to-end messaging system 310 can utilize blockchain technology provided by the distributed ledger module 340 to create a cryptographic hash of each image before obscuring it. The end-to-end messaging system 310 can store these hashes on the blockchain 360 to ensure that the integrity of the images is maintained. Any tampering with the images can be easily detected through hash comparisons.

Proof of Content Submission module 344: The end-to-end messaging system 310 can utilize blockchain technology provided by the distributed ledger module 340 to whenever a user submits an image or message, a blockchain-based proof of submission can be generated. This can be useful in establishing the order of events and preventing disputes over who submitted what content first.

Decentralized Storage 345: The end-to-end messaging system 310 can utilize blockchain technology provided by the distributed ledger module 340 to store obscured images and messages on a decentralized blockchain-based storage system created in blockchain 360. This ensures that data is not held in a central location, reducing the risk of data breaches and unauthorized access.

Smart Contracts for Interaction Rules module 346: The end-to-end messaging system 310 can utilize blockchain technology provided by the distributed ledger module 340 to use smart contracts to define the rules and conditions for interactions between user accounts. For instance, a smart contract could dictate when and how an image's obfuscation should be progressively reduced based on specific triggers.

Privacy and Data Control module 347: The end-to-end messaging system 310 can utilize blockchain technology provided by the distributed ledger module 340 to implement the blockchain 360 and to give users more control over their data. Users could grant explicit permission for their interactions and data to be used for AI enhancements, while maintaining the ability to revoke access at any time.

Traceable Communication module 348: The end-to-end messaging system 310 can utilize blockchain technology provided by the distributed ledger module 340 to all communication between user accounts can be recorded on the blockchain 360, providing a transparent and traceable history of interactions. This can enhance accountability and trust.

Micropayments for Services module 349: The end-to-end messaging system 310 can utilize blockchain technology provided by the distributed ledger module 340 to integrate blockchain-based micropayments for premium services or content. Users could pay small amounts of cryptocurrency to access certain features or receive enhanced communication options.

Consensus Mechanisms for Decision-Making module 350: The end-to-end messaging system 310 can utilize blockchain technology provided by the distributed ledger module 340 to if the system involves collaborative decision-making, blockchain-based consensus mechanisms could be employed to ensure that decisions are made fairly and transparently.

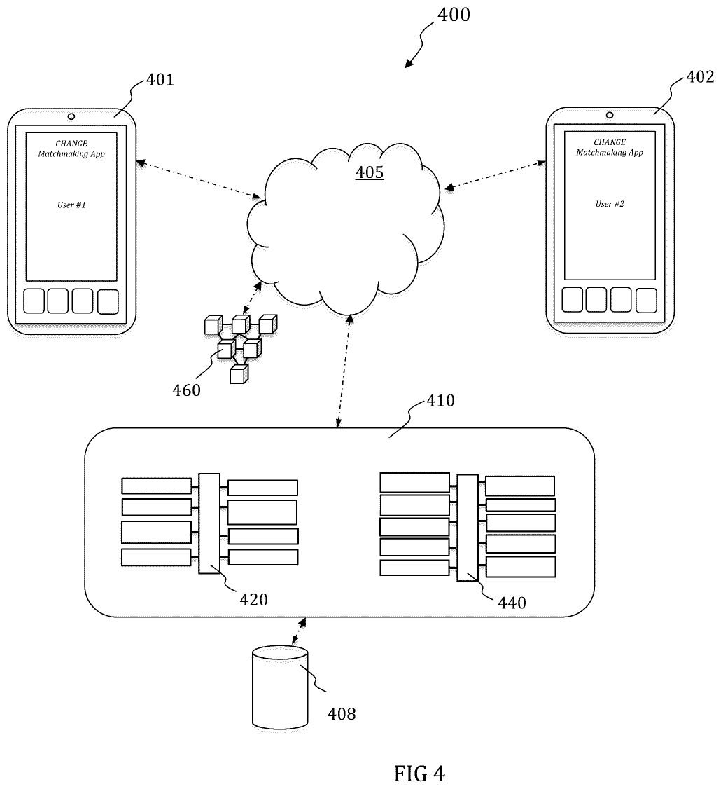

Referring to FIG. 4, illustrated is block diagram 400 of an end-to-end messaging system 410, in accordance with the embodiments. A first client 401 is shown in communication with second client 402 via the end-to-end messaging system 400. AI engine 420 is shown operating in association with the end-to-end messaging system 410. The AI engine can provide features listed and described hereinbefore (referring to FIGS. 1 and 2) on behalf of users of either client 401 or client 402. A distributed ledger module 440 is also shown operating in association with end-to-end messaging system 400 to provide blockchain 460 access and the features also listed and described hereinbefore with respect to FIG. 3.

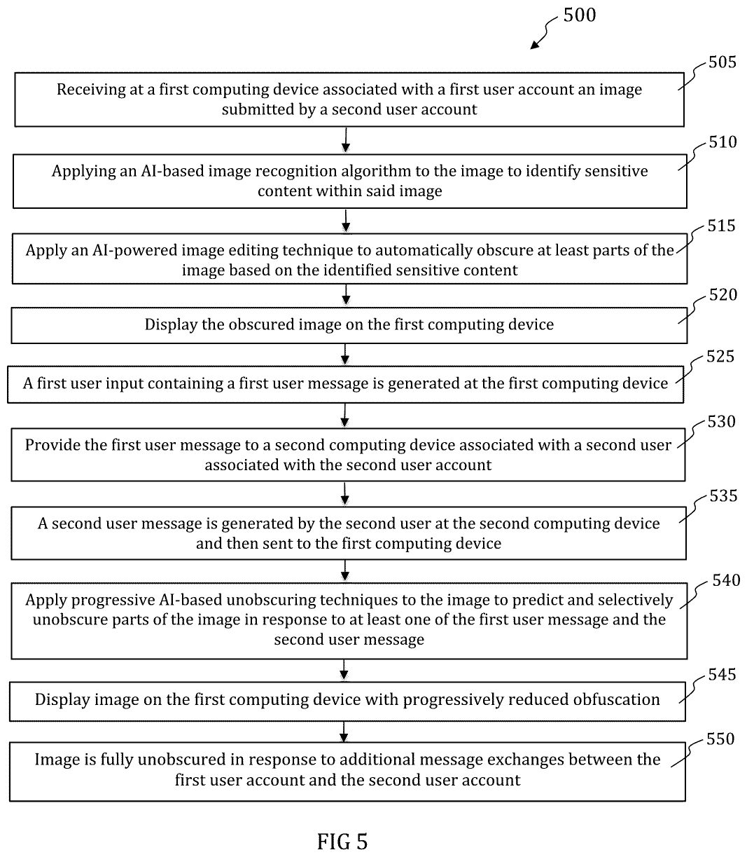

Referring to FIG. 5, illustrated is a flow diagram 500 of a method for facilitating secure communication between user accounts in a computing system, in accordance with carrying out features of the embodiments. As shown in Block 505, a first computing device associated with a first user account receives an image submitted by a second user account. As shown in Block 510, an AI-based image recognition algorithm can be applied to the image to identify sensitive content within said image. An AI-powered image editing technique can then be applied to automatically obscure at least parts of the image based on the identified sensitive content, as shown in Block 515. As shown in Block 520, the obscured image can be displayed on the first computing device. As shown in Block 525, a first user input containing a first user message can be generated at the first computing device. The first user message can be provided to a second computing device associated with a second user associated with the second user account, as shown in Block 530. A second user message can be generated by the second user at the second computing device and then sent to the first computing device, as show in Block 535. As shown in Block 540, progressive AI-based unobscuring techniques can be applied to the image to predict and selectively unobscure parts of the image in response to at least one of the first user message and the second user message. As shown in Block 545, the image can be displayed on the first computing device with progressively reduced obfuscation. Then as shown in Block 550, the image can be fully unobscured in response to additional message exchanges between the first user account and the second user account.

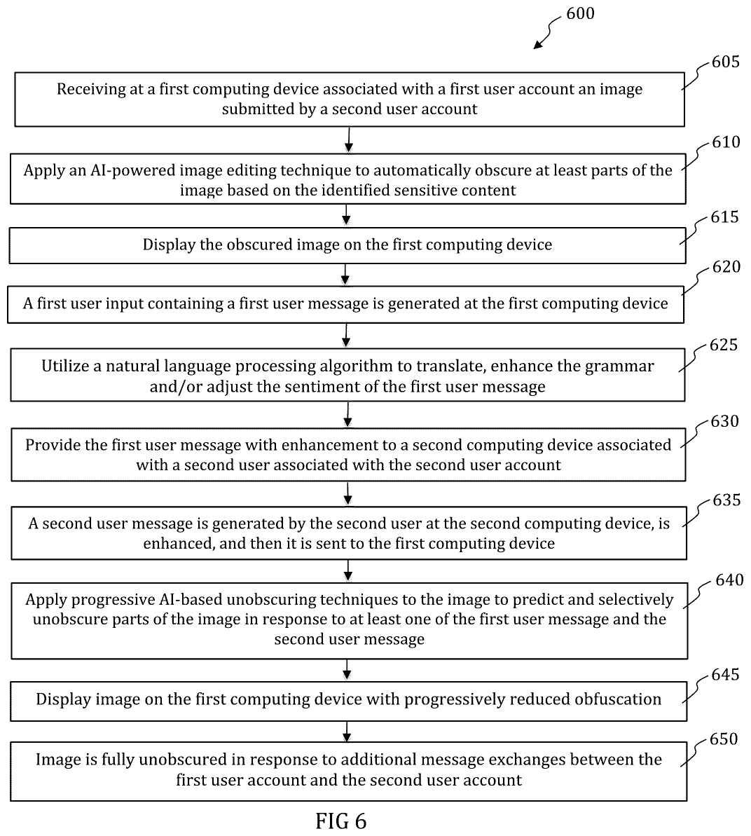

Natural language processing algorithms can be utilized to translate, enhance grammar and/or adjust the sentiment of messages exchanged between users. Translation would be useful, for example, where users speak different languages but still with to communicate. Referring to FIG. 6, illustrated is a flow diagram 600 of another method for facilitating secure communication between user accounts in a computing system, in accordance with carrying out features of the embodiments. As shown in Block 605, a first computing device associated with a first user account receives an image submitted by a second user account. As shown in Block 610, an AI-powered image editing technique can then be applied to automatically obscure at least parts of the image based on the identified sensitive content. As shown in Block 615, the obscured image can be displayed on the first computing device. As shown in Block 620, a first user input containing a first user message can be generated at the first computing device. Then as shown in Block 625, a natural language processing algorithm can be utilized to enhance the grammar and sentiment of the first user message. The first user message with enhancements can then be provided to a second computing device associated with a second user associated with the second user account, as shown in Block 630. A second user message can be generated by the second user at the second computing device, can be enhanced by the natural language processing algorithm, and then sent as enhanced to the first computing device, as show in Block 635. As shown in Block 640, progressive AI-based unobscuring techniques can be applied to the image to predict and selectively unobscure parts of the image in response to at least one of the first user message and the second user message. As shown in Block 645, the image can be displayed on the first computing device with progressively reduced obfuscation. Then as shown in Block 650, the image can be fully unobscured in response to additional message exchanges between the first user account and the second user account.

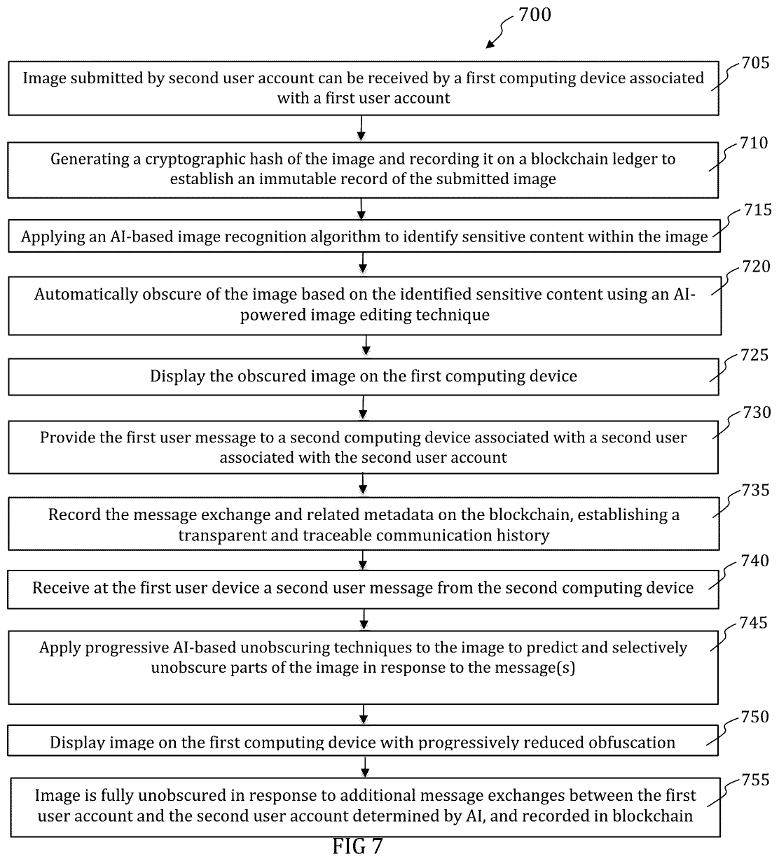

Referring to FIG. 7, illustrated is a flow diagram 700 of a method for secure and transparent communication between user accounts in a computing system, in accordance with another embodiment. Referring to Block 705, an image submitted by a second user account can be received by a first computing device associated with a first user account. As shown in Block 710, a cryptographic hash of the image can be generated and recorded on a blockchain ledger to establish an immutable record of the submitted image. As shown in Block 715, an AI-based image recognition algorithm can be applied to identify sensitive content within said image. At least parts of the image can be automatically obscured based on the identified sensitive content using an AI-powered image editing technique, as shown in Block 720. As shown in Block 725, the obscured image can be displayed on the first computing device. As shown in Block 730, a first user input containing a first user message can be provided to a second computing device associated with a second user account. The message exchange and related metadata can be recorded on the blockchain, establishing a transparent and traceable communication history as shown in Block 735. Referring to Block 740, a second user message from the second computing device is received by the first user device. Progressive AI-based unobscuring techniques can be applied to predict and selectively unobscure parts of the image in response to at least one of the first and second user messages, as shown in Block 745. The image with progressively reduced obfuscation can be displayed on the first computing device, as shown in Block 750. Then as shown in Block 755, the image can be fully unobscured in response to additional messages exchanged between the first user account and the second user account, said additional messages recorded on the blockchain ledger and determined by AI-driven recommendations.

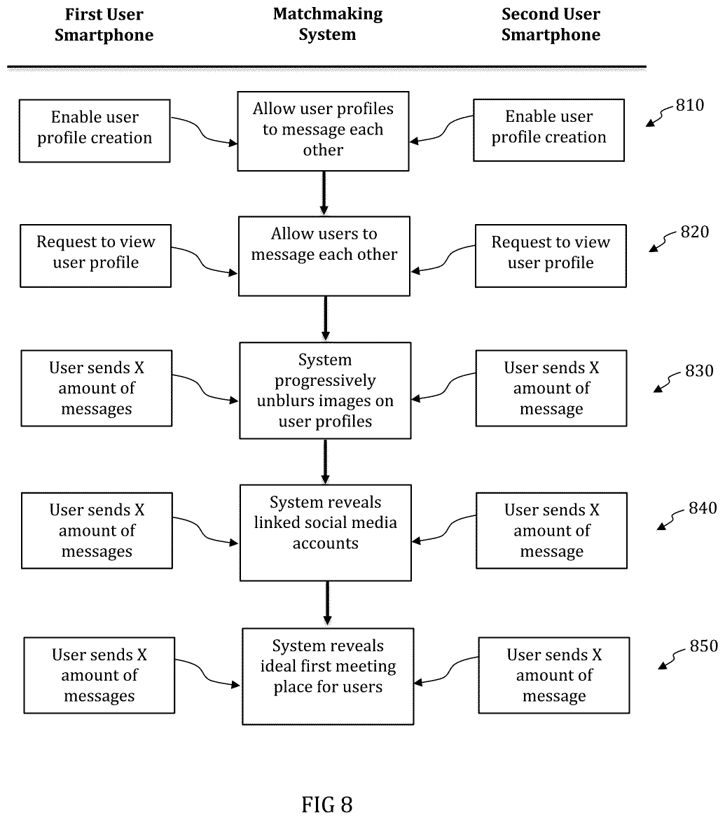

Referring to FIG. 8, illustrates a flow diagram of an example method for facilitating secure communication between two user accounts created within a matchmaking application. As shown in Blocks 710, users can create accounts with a matchmaking application and system and thereafter completes a user profile that provides various information about themselves including any of pictures, demographic information, documents, and biographical narratives. Users can then use the matchmaking application to browse profiles created by other users. The matchmaking application can also show user profiles of other users where the system identifies potential matches based on the profiles. These profiles can obscure data such as images of faces of the respective users so that so that users cannot initially see some content. As shown in Block 720, the system enablers user profiles to message each other. The first and second users can request to view a user profile. The system can progressively unblur images on user profiles as the first user and second user exchange a certain amount (“x”) of messages, as shown in Block 730. Block 740 shows that the system can also reveal linked social media accounts after a certain number of messages have been exchange by the first and second users. Then, as shown in Block 750, the system can reveal an ideal first meeting place for the user after the exchange of a further mount of messages. The number of messages that need to be exchange at each step can be set up by users in their profile or be set by the system.

1. A computing system for enhancing secure communication between user accounts, comprising:
an AI-powered image recognition module configured to receive images submitted by user accounts and automatically identify sensitive content within said images;
an image editing module utilizing AI-based techniques to obscure sensitive parts of the image, while retaining the integrity of the remaining parts;
a natural language processing module enhancing user messages for improved grammar and sentiment;
a recommendation system analyzing user behavior and interactions to determine optimal message delivery times;
an AI-generated summarization module providing condensed versions of conversations;
a progressive unobscuring module using machine learning to gradually reveal parts of obscured images based on user interactions;
an AI-driven security module employing content filtering and anomaly detection to ensure safe user interactions;
chatbots powered by AI to assist users and provide contextual responses;
sentiment analysis algorithms determining emotional tone for appropriate interventions;
personalization algorithms analyzing user preferences to customize message and image displays;
accessibility features including AI-enabled image captioning, text-to-speech, and language translation to accommodate diverse user needs.

2. The system of claim 1, wherein the computing system comprises a dating system.

3. The system of claim 2, wherein demographic information is presented as part of a user profile contained in the user accounts and includes at least one item selected from a group including:
a height of a user;
an age of a user;
a geographic location of a user;
a profession of a user;
a relationship status of a user;
a religion of a user;
a biographical description of a user;
an ethnicity of a user;
a body type of a user;
whether a user smokes;
whether a user drinks alcohol;
whether a user does drugs;
an educational level of a user; and
a language spoken by a user.

4. The system of claim 1, wherein user messages comprise first user content from a user profile created by a first user and second user content from a user profile created by a second user.

5. The system of claim 4, further comprising displaying, by the first computing device because of further interaction between a first user account and a second user account after a first computing device has displayed the second user content with at least part of the second content partially obscured, the at least part of the second user content as unobscured.

6. The system of claim 5, wherein the further interaction between the first user account and the second user account includes the first user account having sent a message to the second user account or the second user account having sent a message to the first user account.

7. The system of claim 5, wherein:
the displaying the second user content with the at least part of the second user content obscured includes displaying text content that was uploaded by the second user account as obscured, the text content being part of a user profile of the second user account; and
the displaying the second user's content with at least part of the second user's content partially obscured includes displaying the text content uploaded by the second user account as partially obscured, such that a first part of the text content is unobscured, and a second part of the text content is unobscured.

8. The system of claim 5, wherein the displaying the second user content with the at least part of the second user content partially obscured is performed because of both:
(i) the first user input having been input at a first computing device, and
(ii) the second user input having been input at a second user device.

9. The system of claim 4, wherein:
the second user content comprises an image captured by a camera of the second computing device; and
the first user content comprises an image captured by a camera of the first computing device.

10. A method for facilitating secure communication between user accounts in a computing system, comprising:
receiving, by a first computing device associated with a first user account, an image submitted by a second user account;
applying an AI-based image recognition algorithm to identify sensitive content within said image;
automatically obscuring at least parts of the image based on the identified sensitive content using an AI-powered image editing technique;
displaying the obscured image on the first computing device;
receiving a first user input containing a first user message;
providing the first user message to a second computing device associated with a second user account;
receiving a second user message from the second computing device;
employing progressive AI-based unobscuring techniques to predict and selectively unobscure parts of the image in response to the second user message;
displaying the image with progressively reduced obfuscation on the first computing device; and
fully unobscuring the image in response to additional messages exchanged between the first user account and the second user account, said additional messages determined by AI-driven recommendations.

11. The method of claim 10, further comprising utilizing natural language processing algorithms to at least one of translate, enhance grammar, and adjust sentiment of said first user message, and then providing the enhanced first user message to a second computing device associated with a second user account.

12. A method for secure and transparent communication between user accounts in a computing system, comprising:
receiving, by a first computing device associated with a first user account, an image submitted by a second user account;
generating a cryptographic hash of said image and recording said hash on a blockchain ledger to establish an immutable record of the submitted image;
applying an AI-based image recognition algorithm to identify sensitive content within said image;
automatically obscuring at least parts of the image based on the identified sensitive content using an AI-powered image editing technique;
displaying the obscured image on the first computing device;
receiving a first user input containing a first user message;
providing the first user message to a second computing device associated with a second user account;
recording the message exchange and related metadata on the blockchain, establishing a transparent and traceable communication history;
receiving a second user message from the second computing device;
employing progressive AI-based unobscuring techniques to predict and selectively unobscure parts of the image in response to the second user message;
displaying the image with progressively reduced obfuscation on the first computing device;
fully unobscuring the image in response to additional messages exchanged between the first user account and the second user account, said additional messages recorded on the blockchain ledger and determined by AI-driven recommendations.

13. The method of claim 12, further comprising utilizing natural language processing algorithms to at least one of translate, enhance grammar, and adjust sentiment of said first user message, and then providing the enhanced first user message to a second computing device associated with a second user account.

14. (canceled)

15. (canceled)

16. (canceled)

17. The computing system of claim 1, further comprising:
a blockchain ledger recording cryptographic hashes of submitted images to establish an immutable and tamper-proof record of image submissions;
a blockchain-based ledger storing message exchanges, user interactions, and related metadata, ensuring transparent and traceable communication; and
an AI-generated summarization module providing condensed versions of conversations.

18. The method of claim 10, wherein user interaction are enhanced as part of a dating application, said method further comprising:
collecting user data during the onboarding process prior to facilitating secure communications between user accounts, said user data including demographic information, interests, and preferences as user profiles;
analyzing the user profiles using natural language processing to extract keywords and themes;
applying machine learning algorithms to identify similarities and patterns between the user profiles, behaviors, and interactions;
utilizing collaborative filtering to suggest potential matches by comparing users with shared interests and preferences;
implementing content-based filtering to match users based on the content of their profiles, messages, and interactions;
employing sentiment analysis to gauge compatibility and chemistry between users;
presenting match suggestions to users based on AI-generated recommendations;
incorporating user feedback to refine the matching algorithms and improve the quality of match suggestions over time;
enabling users to engage in dynamic interactions with suggested matches to further refine compatibility assessments;
providing users with control over their privacy settings and the ability to adjust matching preferences;
ensuring user data security and confidentiality throughout the matchmaking process.

19. The method of claim 12, wherein user interaction are enhanced as part of a dating application including AI-enhanced user interactions and matchmaking, said method further comprising:
employing user profile collection mechanisms gathering demographic data, interests, hobbies, and preferences from users;
employing a natural language processing module analyzing user-written profiles to extract relevant keywords and themes;
employing machine learning algorithms comparing user attributes, behaviors, and interactions to identify patterns and similarities;
employing collaborative filtering techniques suggesting potential matches based on shared interests and preferences;
employing content-based filtering algorithms matching users based on the content of their profiles, messages, and interactions;
employing sentiment analysis mechanisms assessing compatibility and chemistry between users;
employing a recommendation engine providing users with match suggestions based on AI-generated recommendations;
employing feedback integration mechanisms capturing user responses to suggested matches to improve the accuracy of future recommendations;
employing dynamic interaction features enabling users to engage with suggested matches to further refine the matchmaking process;
employing user-controlled privacy settings allowing customization of matching preferences and data sharing permissions; and
employing robust security measures ensuring the protection and confidentiality of user data throughout the matchmaking journey.
